(19) United States
(12) Patent Application Publication
(10) Pub. No.: US 2022/0330694 A1
(43) Pub. Date: Oct. 20, 2022

(54) WINE CABINET WITH ELECTRIC POWER FOR EACH SHELF

(71) Applicant: FRIO ENTREPRISE, Arnage (FR)

(72) Inventors: Didier GRYCHTA, Arnage (FR); Nicolas LIBEAULT, Nantes (FR); Hubert CHEVALIER, Saint Sylvain D'Anjou (FR)

(21) Appl. No.: 17/722,330

(22) Filed: Apr. 16, 2022

(30) Foreign Application Priority Data
Apr. 16, 2021 (FR) 21 03944

(51) Int. Cl. A47B 73/00; A47B 97/00

(52) U.S. Cl. CPC A47B 73/00; A47B 97/00; A47B 2097/003; A47B 2220/0091

(57) ABSTRACT

A wine cabinet, whose façade is equipped with a door, has an interior volume having shelves. Each shelf is movable between two positions. Each shelf is equipped with reception spaces for a plurality of bottles, electronic detectors of the presence of a bottle and electronic devices of visualization of the presence. The power supply of those electronic detectors and electronic devices of visualization comes from a single centralized supply in the cabinet and supplies two vertical conductors placed inside a wall of the cabinet. Each shelf is electrically connected via a connecting cable flexible connect to vertical conductors. The connection shall be arranged at the level of the shelf on the inner face of the wall, the connecting cable having a sufficient length to ensure the connection when the shelf is deployed. Each shelf is equipped with elastic keeping the cable permanently stretched, whatever the position of the shelf.

### CROSS-REFERENCE TO RELATED APPLICATIONS

See Application Data Sheet.

### STATEMENT REGARDING FEDERALLY SPONSORED RESEARCH OR DEVELOPMENT

Not applicable.

### THE NAMES OF PARTIES TO A JOINT RESEARCH AGREEMENT

Not applicable.

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not applicable.

### STATEMENT REGARDING PRIOR DISCLOSURES BY THE INVENTOR OR A JOINT INVENTOR

Not applicable.

### BACKGROUND OF THE INVENTION

### 1. Field of the Invention

The present invention relates to a wine cooler in this case consisting of a temperature controlled and hygrometry controlled cabinet provided with devices for storing bottles. The bottles stored in this type of cabinet are kept under special conditions, allowing optimal preservation of each wine awaiting tasting. They replace and/or improve on wine cellars that were used in the past, and in particular offer capacities for controlling the storage atmosphere that are far superior to the simple residential basement rooms that preceded them. These cabinets, preferably placed in rooms where they can be shielded from light, can also benefit from current technologies for the creation and fine management of an atmosphere favorable to the storage of bottles. The present invention also relates to a so-called connected cooler which benefits from a number of technological advances to facilitate its use by its owners.

### 2. Description of Related Art Including Information Disclosed Under 37 CFR 1.97 and 37 CFR 1.98

In these cabinets, the front of which has a door giving access to the storage space, the bottles are traditionally stored horizontally. To minimize both costs and space, provision is also made to store as many bottles as possible in a space that takes up most of the cabinet's interior volume. The bottles are arranged in rows in said volume, on superimposed shelves which have to provide storage and individualized access to a maximum number of bottles. For this purpose, each shelf is equipped with spaces for receiving a plurality of bottles arranged head to tail. This storage by superimposed shelves makes it possible to ensure, on the one hand, the horizontal position of said bottles and, on the other hand, air circulation which allows the even distribution of temperature and humidity.

This requirement to optimize the number of bottles stored must obviously not conflict with the need for easy and individualized access to each bottle to be extracted, and the shelves are therefore designed to be slidable. Each shelf is therefore movable between two positions, i.e. extended out of the rack, allowing the extraction of the selected bottle, and retracted into the volume of the latter.

### BRIEF SUMMARY OF THE INVENTION

Since the wine cooler of the invention is equipped with electronic means for signaling and detecting the individual spaces, indicating those which are occupied by a bottle and those which are empty, each shelf must therefore be electrically powered in order to operate the components necessary for said advanced signaling and detection functions. The wine cooler's power supply comes from a single mains connection, arriving at a predetermined location in the cabinet, and the electrical characteristics thereof (current, voltage, etc.) are then transformed to be able to provide the strong signals necessary for the operation of the various components of each shelf. In this respect, the sliding movement of the shelves poses the problem of the mobility of the unit to be powered, which must not be at the expense of the quality of the connection.

It is of course possible to start from a centralized connection of the flexible conductor cables conveying the electrical energy to each shelf, by using an “octopus” type assembly, but this solution has numerous drawbacks. Providing one cable per shelf means in this case that there will be a plurality of cables of different lengths in the interior volume of the cabinet, which is unsightly and costly if all the lengths are added together, and the presence of these cables may also prove to be problematic because their proliferation is likely to hinder the movement of the shelves. Organizing them into bundles to avoid a disordered presence in the cabinet volume generally leads to less flexibility, with the risk of making it more difficult for the user to handle the shelves, in particular when they are pushed back into the interior space. Moreover, in the specific environment of a wine cooler, the installation of a bundle of electrical cables near the evaporator of the refrigeration circuit imposes constraints.

Finally, if they remain individualized, and if they hang in the interior space close to the shelves, the cables are potentially more prone to inadvertent disconnections or pull-outs. It should be noted that the connection cables of the shelves which are distal from the power supply, which have the greatest length, exacerbate somewhat all the drawbacks mentioned above. The risks of cables becoming entangled with the shelves, or snagging on bottles or other obstacles, although always present, are obviously greater for the longer cables.

The invention overcomes these multiple limitations and problems by proposing an optimized power supply solution with in particular uniform wiring, regardless of the location of the shelf in the cabinet constituting the wine cooler. This solution also optimizes the uniform length of the connection cables and makes it possible to very precisely control their positioning in relation to the shelf to which they supply power, regardless of the positioning of the shelf in relation to the cabinet. Finally, the power cables are no longer visible to the user; they are managed by the system so as to be somewhat “tidy” at all times, independently of the movements of the shelf.

Thus, according to the invention, the electrical power supply of said electronic detection means and of said electronic display means comes from a single centralized power supply in the cabinet which supplies two vertical conductors located inside a wall of the cabinet, each shelf being electrically connected via a flexible connection cable to means for connecting said cable to the vertical conductors, these connection means being arranged in the region of the shelf on the inner face of said wall. In addition, said flexible connection cable has a sufficient length to ensure the connection when the shelf is extended, and each shelf is provided with elastic means capable of keeping the cable taut at all times, whatever the position of the shelf.

In other words, the solution proposed by the invention manages the movement of identical flexible connection cables, said management being carried out such that they are continuously and permanently under control, regardless of the movements otherwise imparted to said shelves. These individual connection cables are, due to the double distribution of the power supply, first vertical then horizontal, of minimal length and calibrated to supply power to only one shelf, i.e. the one located in the region of the means for connecting the cable to the vertical distribution of the power supply. Said connection means are in practice distributed along one of the side walls of the cabinet.

According to one possibility, the elastic means can consist of an elongate elastic tensioner having an end loop through which the connection cable passes, angularly dividing it into a first portion extending from the connection means to the end loop of the tensioner and a second portion extending from said end loop to a point of attachment of the flexible cable to the shelf, the two portions together forming a cable length which makes it possible to maintain the connection when the shelf is extended, the tensioner being secured to the shelf at its end opposite the loop.

The tensioner grows elastically when the shelf is extended, because the connecting cable exerts traction on the end loop as the angle formed by the portions of the flexible cable becomes more obtuse. When the shelf is completely closed, this angle is on the contrary very acute, the two portions becoming almost parallel and one of them being substantially in contact with the shelf. Because the connection means are located in the region of the shelf and the tensioner is secured to said shelf, these portions are in practice located in the volume covered by the movement of the shelf, more precisely in the volume between the lower and upper planes enveloping the horizontal shelf.

Preferably, the means for connecting the flexible cable to the vertical conductors are located close to a corner edge of the cabinet separating the back wall of the cabinet located opposite the door and a side wall, in the region of the vertical conductors, and the tensioner is secured to the rear crosspiece of the shelf facing said back wall, close to the opposite corner edge.

In this case, the connecting cable becomes invisible when the shelf is retracted, since it does not hang down due to the elastic tension provided by the tensioner and because it is located in the horizontal volume footprint of the shelf when it is moved, and in the rear part thereof.

More preferably, the vertical conductors are conductive bars located inside a side wall of the cabinet. This power supply by conductivity in metal bars molded into the wall considerably simplifies the electrical distribution to the shelves. Each shelf thus benefits from a power supply of e.g. DC 5V and 3 A, adapted to the electronics which reside in each shelf, which will be mentioned in more detail below.

At one of the ends of the connection cable, the means for connecting the cable to the vertical bars consist for example of conductive screws passing through eyelets provided on the end of conductors emerging from a sheath at a first free end of the flexible cable, said conductive screws passing through the wall of the cabinet in the direction of the conductive bars provided with threaded holes, into which bars they are screwed.

According to one possible configuration of the invention, the means for connecting the flexible connection cable can comprise a cover made of insulating material covering the eyelets and provided with a system for securing the end of the flexible connection cable, said cover being secured to the inner face of the wall by means of the conductive screws.

The flexible cable is therefore secured to the insulating cover, which makes it possible to avoid any unwanted traction on the eyelets establishing the electrical connection. The solution used makes it possible to mechanically secure the cover and the eyelets by means of a conductive component which therefore fulfills a second electrical connection function. According to one possible configuration, the system for securing the flexible connection cable to the insulating cover consists of internal reliefs of the cover comprising a clamp constituting a clip for elastically retaining a first overmolded ring on the outside of the sheath of the flexible cable surrounding the constituent wires of said cable.

The flexible connection cable is also rigidly connected to the shelf by attachment means located in the region of the crosspiece supporting the tensioner. These means of attachment to the shelf can for example consist of a clip which is secured to the shelf and is capable of elastically clipping a second overmolded ring provided on the sheath of the flexible connection cable. Here again, the objective is to avoid modifying the organization of the rigid connection of the cable to the shelf, which is important in the mechanical logic implemented to ensure the permanent tension of the cable.

In fact, the flexible connection cable may be provided only to connect the power supply to the wine cooler at the rear of each shelf, and not take charge of the power supply for the electronic functions provided on the shelf. In this case, it must have a length slightly greater than the distance separating the extended shelf from the power supply bars. According to the invention, the cable can then be equipped with a connector located at a second free end and close to the second overmolded ring, cooperating with a connector secured to the shelf close to the clip.

Other aims and advantages of the present invention will become apparent throughout the following description relating to an embodiment which is given only by way of an indicative and non-limiting example.

### BRIEF DESCRIPTION OF THE SEVERAL VIEWS OF THE DRAWINGS

The understanding of this description will be facilitated in particular by referring to the drawings attached in the annex.

FIG. 1 represents an exploded perspective view of a shelf according to the invention, whose components for managing the voltage of the flexible connection cable are shown enlarged.

FIG. 2 shows an elevated schematic view of such a flexible patch cable.

FIG. 3 illustrates a perspective view of the operation of the voltage management of the flexible connection cable.

FIG. 4 represents a perspective view of the inside of the insulating material cover.

FIG. 5 shows a perspective view of a part of the side wall on which the covers are in the rear extension of the sliding slides of the shelves.

FIG. 6 shows the same perspective view, on the opposite side, i.e. from the side wall.

### DETAILED DESCRIPTION OF THE INVENTION

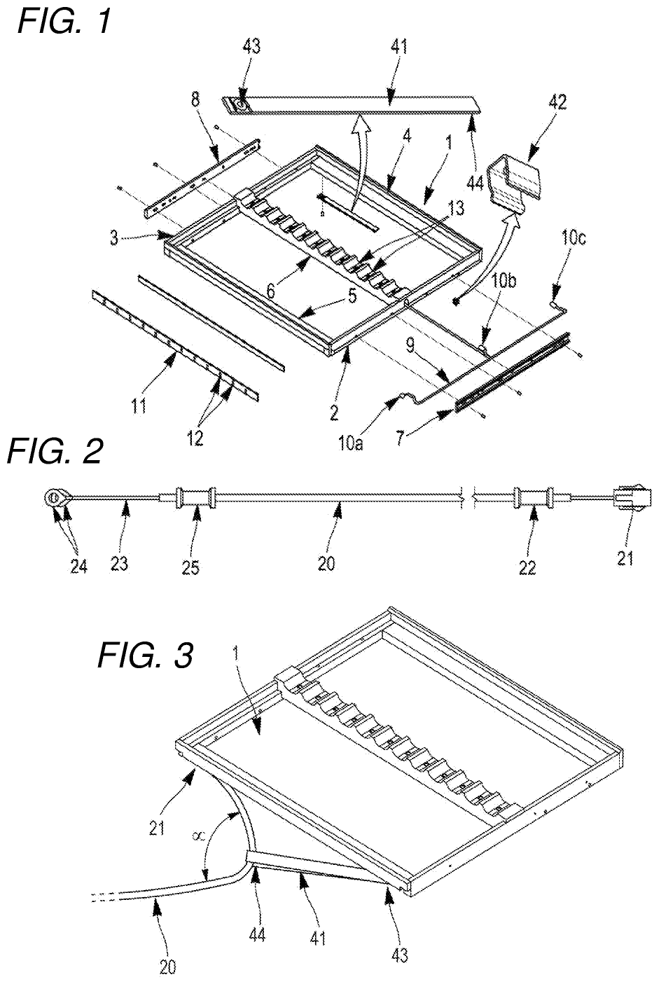

Referring to FIG. 1, the shelf 1 very generally comprises two side members 2, 3, two crosspieces 4, 5 and a central bar 6 shaped to accommodate bottles. The side members 2, 3 are provided with rails 7, 8 which are screwed therein and allow them to slide in the slides fitted to the side walls of the cabinet of the wine cooler (not shown). The side member 2 further comprises an internal connecting cable 9 provided with three connectors 10a, 10b and 10c making it possible to distribute DC electrical voltage and current to internal circuits providing the electronic functions mentioned above. These voltage/current signals are supplied to the shelf 1 by the cabinet power supply via the flexible connection cable 20 shown in FIG. 2.

The connector 10a thus makes it possible to supply power, by connection to a printed circuit that manages it, to a bar 11 of light-emitting diodes 12 which signal the presence of bottles in the spaces formed in the central bar 6. This bar 11 of diodes 12 is provided on the crosspiece 5 located at the front of the shelf 1, i.e. the one which is therefore located close to the cabinet door and is visible to users. The connector 10b also supplies power to a printed circuit located in the central bar 6 and which manages detectors 13 for detecting the presence of the bottles. The third connector 10c allows a connection to a connector 21 of the flexible cable 20 of FIG. 2. It is via this connector that the connection to the centralized power supply of the wine cooler of the invention is established.

The crosspiece 4, which is therefore the rear crosspiece of the shelf, thus facing the back wall of the cabinet and distal to the door, comprises two specific components which allow the management of the flexible connection cable 20 with respect to the shelf 1 and which are enlarged relative to the scale of the rest of FIG. 1: the tensioner 41 and a clip 42 for securing the flexible connection cable 20.

The tensioner 41 is secured close to one of the ends of the crosspiece 4 via a screw passing through an eyelet 43. The clip 42 is also secured via a screw, close to the other end of the crosspiece 4. The two securing points are also preferably located on the same face of the crosspiece 4. The tensioner 41 is actually an elastic band of which the free ends are secured to each other at the eyelet 43. The end of the tensioner 41 which does not have the eyelet 43 has a loop 44 in which the flexible cable 20 is slid, as shown in FIG. 3. It is at this loop 44 that the return force is exerted by the elastic tensioner 41 on the cable 20. The characteristics of this tensioner 41 can e.g. be the following: it can be composed of 50% polyester and 50% latex.

The sheath of the flexible connection cable 20 has, close to its end connector 21, an overmolding in the form of a ring 22 intended to clip elastically into the clip 42 when the connectors 21 and 10c are connected. This clipping secures the flexible cable 20 to the crosspiece 4 of the shelf 1, at the location chosen for the proper functioning of the mechanical system, and it also prevents any pulling-out that could damage the connector 21, or the connector 10c. In the representation of FIG. 3, the connection and the clipping of the overmolded ring 22 on the sheath of the cable 20 into the clip 42 are on an underside of the crosspiece 4 not visible in the figure, which shows a perspective view from above of the shelf 1. Similarly, the securing of the tensioner 41, via the eyelet 43, at the other end of said crosspiece 4 is not visible either.

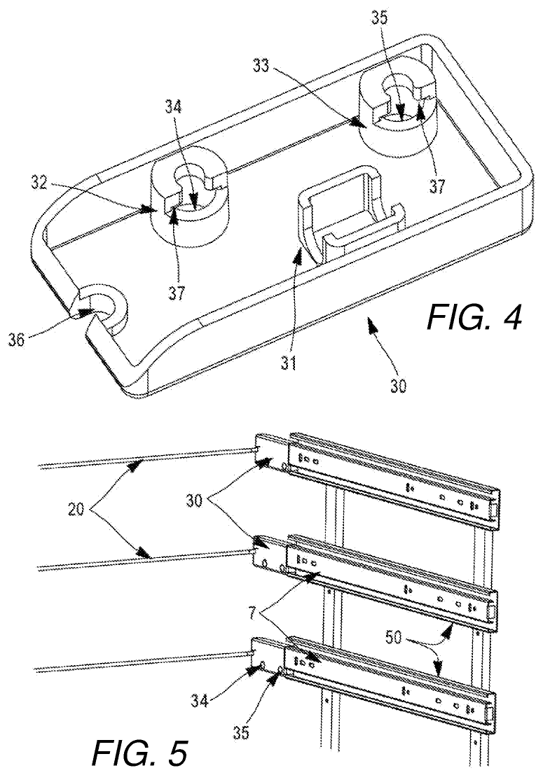

As shown in FIG. 2, at the other end of the connection cable 20, the sheath is interrupted to let out individual conductors 23 to which eyelets 24 are welded. These allow the corresponding end of the flexible cable 20 to be secured by screwing to the electricity distribution bars provided, as mentioned, e.g. on a side wall of the cabinet. This securing is achieved by an insulating cover 30 (see in FIG. 4) itself secured to said wall by the same screws, and the internal face of which comprises reliefs defining a clip for rigidly connecting a second overmolded ring 25 provided on the other free end of the flexible cable 20, thus preventing traction or any inadvertent stress from damaging the flexible cable 20 or cutting the electrical connection.

More specifically, the insulating cover 30 comprises, inside the volume that it delimits, a clamp 31 in which the overmolded ring 25 is clipped, which is therefore firmly attached. A notch 36 made in one of the edges of the cover 30 allows the passage of the cable 20, upstream of said ring 25, so as not to hinder the securing of the cover 30 in contact with the wall of the cabinet. The cover 30 also comprises two holes 34, 35 for the passage of the conductive screws for securing to said wall, which holes are surrounded by truncated guide bushings 32, 33, a portion of the peripheral wall of the inner end of the bushings 32, 33 being missing. The absence of a wall at this location makes it possible to insert the eyelets 24 into the bushings 32, 33, perpendicularly to their axis, so that they can be positioned substantially coaxially with said bushings 32, 33, that is to say also coaxially with the securing screws. A slot 37 is also provided for this purpose, of the same thickness as that of the eyelet 24, so that when it is inserted therein it cannot move from the centered position in the bushing 32, 33. Contact with the screw passing through it is therefore ensured.

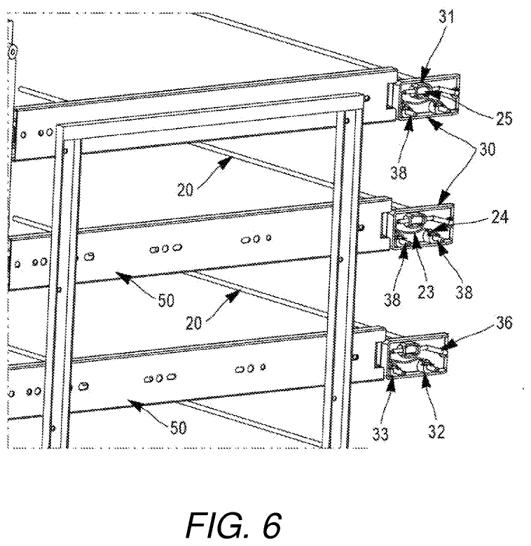

FIGS. 5 and 6 show where and how these covers 30 are installed in the wine cooler of the invention. Thus, they are positioned in the extension of the slide rails of the shelves 1, that is to say in the continuation of the rails 7 slidably mounted in the slides 50 attached to the side walls. The covers 30 are in this case located at the rear of said slide rails, close to the corner edge between the side wall and the back wall of the cabinet, opposite the front door. More particularly, FIG. 5 shows the location of the holes 34, 35 for inserting screws 38 for securing (see FIG. 6) conductors of the covers 30 to the wall.

As can be seen in FIG. 6, the end portion of the flexible cable 20 which is housed in the cover 30 enters the interior volume of said cover 30 via the circular notch 36. The overmolded ring 25 of the sheath of the flexible cable 20 is clipped into the clamp 31, so that any risk of pulling out is excluded. The eyelets 24 at the end of the conductors 23 are inserted into the slots 37 (see FIG. 4) and are therefore centered in the guide bushings 32, 33 of the conductive screws 38 for securing to the vertical power supply bars.

The operation, which is easy to understand with reference to FIG. 3, is as follows: when the shelf 1 is pulled outward, the flexible cable 20 is stretched and the value of the angle a increases, as does the length of tensioner 41 in the direction of movement of the shelf 1. The cable 20 is therefore provided with a total length that allows the shelf 1 to be extended as far as its exit stop, that is to say fully extended. As soon as the shelf 1 is retracted into the volume of the cabinet, the tensioner 41 exerts a restoring force on the bend of the flexible connection cable 20, the angle a decreases and the portion of said cable 20 located between the tensioner 41 and the crosspiece 4 is driven toward said crosspiece. In the fully retracted position of the shelf 1, the two portions of the cable 20 on either side of the loop 44 of the tensioner 41 are practically parallel, almost in contact with the rear crosspiece 4, and completely invisible to the user.

The solution makes it possible to ensure optimum operation of the management of the power supply of the plurality of superimposed shelves 1, without impeding their movement.

The example given above with reference to the attached figures is not exhaustive or limiting of the invention, which in particular includes shape variants for the tensioner 41, the clip 42, as well as composition variants of the tensioner 41, etc.

1. A wine cabinet, comprising:
a façade is equipped with a door;
shelves in an interior volume, the shelves sliding superimposed, each shelf being movable between two positions respectively deployed out of the interior volume and retracted in said interior volume, each shelf being equipped with reception spaces for a plurality of cylinders, electronic means of detecting the presence of a cylinder in each location and electronic means of viewing the occupation of each location;
a power supply of said electronic means of detection and those electronic means of viewing from a single centralised supply in the cabinet;
two vertical conductors placed inside a wall of the cabinet; and
connection cables for each shelf being electrically connected to said two vertical conductors, those means of connection being arranged at the level of the shelf on the inner face of that wall, the said flexible connecting cable having a sufficient length to ensure the connection when the shelf is deployed, and each shelf being equipped with elastic means capable of keeping the cable stretched at all times, whatever the position of the shelf.

2. The wine cabinet, according to claim 1, wherein the elastic means comprises: an elongated elastic tensioner having an end loop through which passes the connecting cable, dividing the latter angularly into a first section from the means of connection to the end loop of the tensioner and a second section from said end loop to a point of attachment of the cable flexible to the shelf, the two sections together forming a length of cable to maintain the connection when the shelf is deployed, the tensioner being attached to the shelf at its end opposite to the loop.

3. The wine cabinet, according to claim 2, wherein the means of connection of the flexible cable to the vertical conductors are placed in the vicinity of a corner edge of the cabinet separating the bottom wall of the cabinet located opposite the door and a side wall, at the level of the vertical conductors, and the tensioner is fixed on the rear cross member-4 of the shelf located opposite the said bottom wall, in the vicinity of the opposite corner edge.

4. The wine cabinet, according to claim 1, wherein the vertical conductors are conductive bars placed inside a side wall of the cabinet.

5. The wine cabinet, according to claim 4, wherein the means of connection of the cable to the vertical bars comprises conductive screws passing through eyelets equipping the end of conductors emerging from a sheath at a first free end of the flexible cable, said conductive screws passing through the wall of the cabinet in the direction of the conductive bars with threaded orifices, bars in which they are screwed.

6. The wine cabinet, according to claim 5, wherein the means of connection of the flexible connecting cable comprise a cover of insulating material covering the eyelets and provided with a system for fixing the end of the cable flexible connection, said cover being fixed to the inner face of the wall by means of the conductive screws.

7. The wine cabinet, according to claim 6, wherein the system of fixing the flexible connection cable to the insulating cover further comprises: interior reliefs of the cover comprising a stirrup constituting an elastic hanging clip of a first ring over-molded on the outside of the sheath of the flexible cable surrounding the wires constituting the said cable.

8. The wine cabinet, according to claim 2, wherein the flexible cable is solidarized to the shelf by means of attachment placed at the level of the cross member supporting the tensioner.

9. The wine cabinet, according to claim 8, wherein the means of attachment to the shelf comprises: a clip fixed to the shelf and elastically clipping a second ring over-molded equipping the cable sheath connection flexible.

10. The wine cabinet, according to claim 9, wherein the flexible connection cable is equipped with a connector located at a second free end and near the second ring over-molded, cooperating with a connector attached to the shelf in the vicinity of the clip.
